(19) United States
(12) Patent Application Publication
(10) Pub. No.: US 2012/0240503 A1
(43) Pub. Date: Sep. 27, 2012

(54) System and method for building with compressed masonry blocks

(75) Inventor: David G. White, Lookout Mountain, GA (US)

(73) Assignee: RamRock Building Systems LLC

(21) Appl. No.: 13/065,556

(22) Filed: Mar. 24, 2011

(51) Int. Cl. E04B 2/16; B28B 5/02; E04G 21/16; E04G 21/02

(52) U.S. Cl. 52/426; 425/62; 264/241; 52/745.2

(57) ABSTRACT

A system and method for building on a worksite utilizing compressed masonry blocks is provided. The method includes the steps of providing a block machine at or near a worksite for the structure, providing reusable material at or near the worksite as block material for forming a plurality of compressed blocks, manufacturing each of the plurality of compressed blocks by the block machine by compressing a measured portion of the block material under a pressure in the range of 2500 to 5000 psi, and forming the structure on the worksite from one or more of the plurality of compressed blocks. The reusable material includes common clay, foundry sand, coal ash, construction debris, demolition debris, waste road asphalt, or waste roof shingles. The step of manufacturing each of the plurality of compressed blocks includes the steps of measuring usage information and operational parameter information for the block machine, determining location information for the block machine, and transmitting the usage information, operational parameter information, and location information.

### FIELD OF THE INVENTION

The present invention generally relates to systems for building structures constructed with compressed blocks, and more specifically to systems and methods for forming such blocks and for building structures utilizing such blocks.

### BACKGROUND OF THE DISCLOSURE

Compressed masonry blocks, or simply compressed blocks, are used in various building structure applications, such as retaining walls; landscaping features; roads, driveways, sidewalks, and patios; and support walls, partitions, flooring, and roofing in buildings. The compressed blocks may have vertical and interlocking structures with mating surfaces so that building structures can be built without the need for mortar or to enhance the strength of structures that also include mortar.

There exists a need for providing an efficient system and method for forming compressed blocks and a system and method for constructing economically viable and ecologically sound structures using the compressed blocks. Furthermore, other desirable features and characteristics will become apparent from the subsequent detailed description and the appended claims, taken in conjunction with the accompanying drawings and this background of the disclosure.

### SUMMARY OF THE INVENTION

According to the Detailed Description, a system for building on a worksite utilizing compressed blocks is provided. The system includes a block machine for manufacturing a plurality of compressed blocks and one or more structures assembled on the worksite. The block machine is portable for locating on or near the worksite, includes interchangeable molds and a hydraulic block cutter for forming the plurality of compressed blocks in a variety of shapes and sizes, and includes a communication module for communicating information including location information, usage information and operational parameter information. The one or more structures include one or more of the plurality of compressed blocks.

In addition, a method for building a structure is provided. The method includes the steps of providing a block machine at or near a worksite for the structure, providing reusable material at or near the worksite as block material for forming a plurality of compressed blocks, manufacturing each of the plurality of compressed blocks by the block machine by compressing a measured portion of the block material under a pressure in the range of 2500 to 5000 psi, and forming the structure on the worksite from one or more of the plurality of compressed blocks. The reusable material includes common clay, foundry sand, coal ash, construction debris, demolition debris, waste road asphalt, or waste roof shingles. The step of manufacturing each of the plurality of compressed blocks includes the steps of measuring usage information and operational parameter information for the block machine, determining location information for the block machine, and transmitting the usage information, operational parameter information, and location information.

Further, a building structure is also provided. The building structure includes compressed blocks and the building structure includes a first wall formed from a first set of the compressed blocks, a second wall formed from a second set of the compressed blocks, and one or more bracing blocks from a third set of the plurality of compressed blocks. The one or more bracing blocks interspersedly connect the first wall to the second wall. And the first and second walls are substantially parallel and non-adjacent such that a channel is formed between them. An outer surface of the first wall is opposite the channel and forms an exterior surface of the structure. And, an inner surface of the second wall is opposite the channel and forms an interior surface of the structure.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with the present invention.

FIG. 1 is a block diagram of a system for building a structure utilizing compressed blocks in accordance with a present embodiment;

FIG. 2 is a block diagram of the block machine of the system of FIG.1 in accordance with the present embodiment;

FIGS. 3A and 3B are top, rear, left perspective views of the block machine of the system of FIG.1 in accordance with the present embodiment, wherein FIG. 3B is an exploded perspective view of the block machine;

FIG. 3C is a front planar view of a block cutter of the block machine of FIGS. 2, 3A and 3B in accordance with the present embodiment;

FIG. 3D is a front, right, top perspective view of the block cutter of the block machine of FIGS. 2, 3A and 3B in accordance with the present embodiment;

FIG. 4A is a top planar view of a compressed block in accordance with the present embodiment;

FIG. 4B is a front planar view of the compressed block of FIG. 4A in accordance with the present embodiment;

FIG. 4C is a left side planar view of the compressed block of FIG. 4A in accordance with the present embodiment;

FIG. 4D is a top front left perspective view of the compressed block of FIG. 4A in accordance with the present embodiment;

FIG. 5, including FIGS. 5A, 5B, 5C and 5D, are views of a wall utilizing the compressed blocks of FIG. 4 (including FIGS. 4A, 4B, 4C and 4D) in accordance with the present embodiment, wherein FIGS. 5A is a top planar view, FIG. 5B is a front planar view, FIG. 5C is a side planar view and FIG. 5D is a front, right, top perspective view;

FIG. 6 is a top planar view of a first structure utilizing the compressed blocks of FIGS. 4A, 4B, 4C and 4D in accordance with a first structure embodiment; and

FIG. 7 is a top planar view of a structure utilizing the compressed blocks of FIGS. 4A, 4B, 4C and 4D in accordance with a second structure embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention.

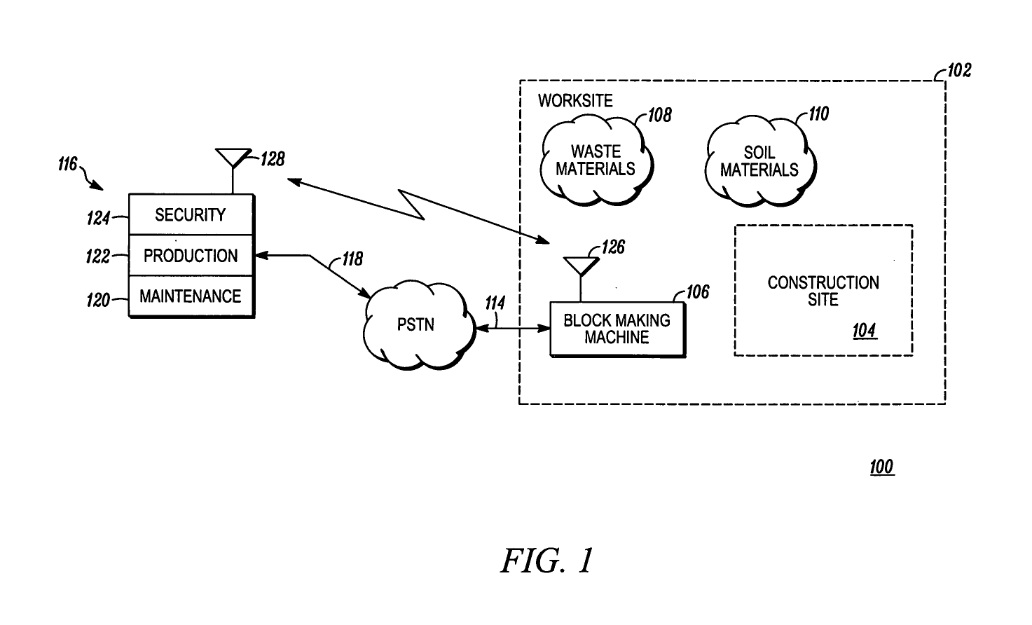

Referring to FIG. 1, a system 100 for building on a worksite 102 utilizing compressed blocks is depicted. The worksite 102 includes a construction site 104 where one or more structures will be assembled. In accordance with the present embodiment, a block forming machine 106 is a portable device for manufacturing the blocks and is located on the worksite 102. A variety of nonhazardous municipal and/or industrial waste materials 108 include, but are not limited to, reusable materials such as construction or demolition debris, spent foundry sand, coal ash or other incinerator ash or combustion waste, waste glass, waste road asphalt or waste roof shingles. Soil materials 110, such as common soil or clay or foundry sand, are provided on the worksite 102 along with the waste materials. The block forming machine 106 manufactures the blocks and other related building products, such as pavers or roof tiles, from the waste materials 108 and the soil materials 110 by compressing the waste materials 108 and/or the soil materials 110 under intense hydraulic pressure.

During operation, the block forming machine 106 measures operational parameter information related to the operation of the block forming machine 106 for maintenance purposes. In addition, the block forming machine 106 measures usage information (e.g., number of blocks manufactured). The usage information could be used for determining usage-based royalties for a licensing arrangement. Further, the block forming machine 106 determines location information identifying the location of the block forming machine 106 for security purposes.

The block forming machine 106 may be coupled to a public switched telephone network (PSTN) 112 or any other type of landline coupling system via a communication path 114. The block forming machine 106 uploads the location information, the usage information and the operational parameter information to a central database 116 through the PSTN 118 by accessing (i.e., calling) the central database via communication path 118. The central database 116 stores maintenance information 120 (including the operational parameter information), production information 122 (including the usage information), and security information 124 (including the location information).

Alternative to, or in addition to, landline communication via the PSTN 112, the block forming machine 106 may communicate with the central database via radio frequency (RF) communication such as satellite RF communication or cellular communication. Thus, the block forming machine may be coupled to an antenna 126 and the central database 116 may be coupled to an antenna 128 to enable communication via an RF communication path 130. While a simplified, direct RF communication path 130 is depicted in FIG. 1, those who are skilled in the art will realize that the RF communication path 130 may include a cellular communication system, including one or more base stations, or may include a satellite communication system, including one or more satellites and, possibly, one or more terrestrial relay stations.

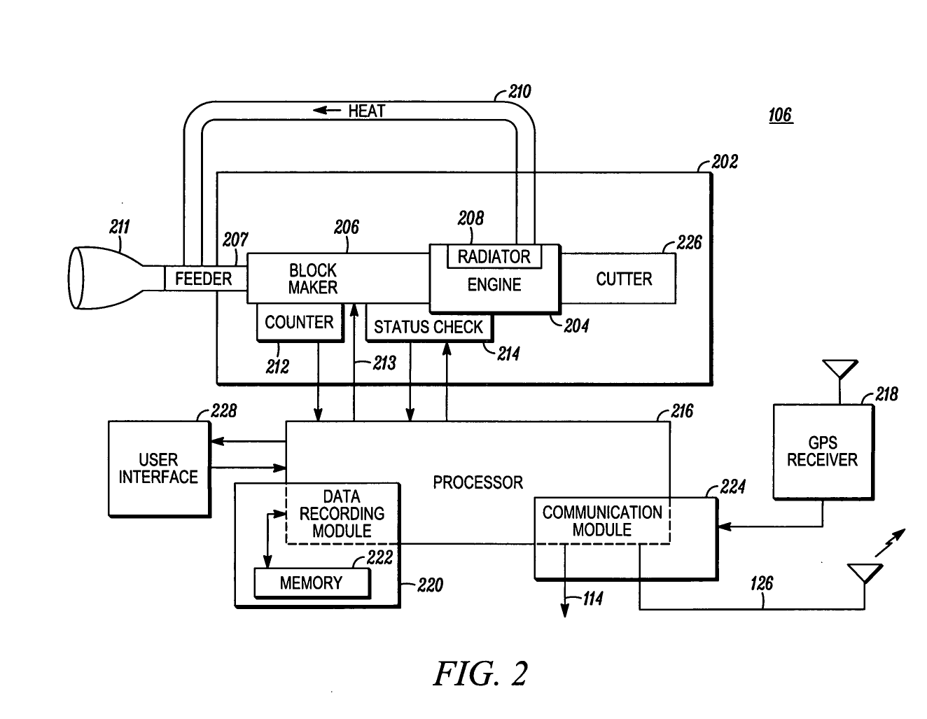

Referring to FIG. 2, the block forming machine 106 includes a block formation module 202 for forming the blocks under hydraulic pressure. An engine 204 is coupled to a block maker 206 and generates intense hydraulic pressure in the range of 2500 to 5000 pounds per square inch (psi) for the block maker 206 to compress a measured portion of the waste materials 108 and the soil materials 110 (FIG. 1) to manufacture the blocks. In accordance with the present embodiment, heat is used to soften the asphalt-based materials 108 prior to the compression of those materials 108, such as by infrared heat lamps positioned in a feeder 207 forwarding the materials 108 to the block maker 206 or channeled by a hose 210 or other means from waste heat to the feeder 207, for example, from a radiator 208 of the engine 204. The feeder 207 may be any device such as a conveyor or an auger for forwarding the materials 108, 110 to the block maker 206. In accordance with the present embodiment, a suction hose delivery system 211 may be coupled to the front end of the feeder 207 and may extend twenty-five feet or more from the feeder 207 to load the soil 110 and the materials 108 into the feeder 207, thereby precluding the need for additional equipment, such as a “bobcat” front-loader for machine-loading the soil 110 and materials 108 or shovels for hand-loading the soil 110 and materials 108.

A counter 212 is coupled to the block maker 206 to count the blocks that are manufactured by the block maker 206 and to measure other usage information (e.g., time activated). A status check module 214 is also coupled to the block maker 206 to check the status of various operational parameters during the operation of the block maker 206. The status check module 214 forwards information to a processor 216, the information indicative of various operational parameters of the block maker 206. The counter 212 also forwards information indicative of the count of the blocks formed by the block maker 206 to the processor 216.

The processor 216 generates the operational parameter information from the information received from the status check module 214. In addition, the processor 216 generates usage information from the information received from the counter 212. A GPS receiver 218 receives Global Positioning System signals and generates information therefrom indicative of a location of the GPS receiver 218. The GPS receiver 218 forwards this location information to the processor 216.

A data recording module 220 includes a non-volatile memory 222 and a portion of the processor 216. The data recording module 220 stores the location information, the usage information and the operational parameter information in the memory 220. A communication module 224 includes another portion of the processor 216. The communication module 224 determines a communication time and, at the communication time, retrieves the location information, the usage information and the operational parameter information from the memory 220 and provides to one or both of the communication paths 114 for landline communication and the antenna 126 for RF communication as described hereinabove.

The block forming machine 106 in accordance with the present embodiment is able to form multiple types of compressed blocks. In order to accomplish this, the block maker 206 will include easily interchangeable molds. For example, molds for vertically or horizontally interlocking compressed blocks, molds for specially formed blocks (e.g., full blocks, cap blocks and partial blocks), and molds for other related building products will be included. In addition, the block maker 206 will be able to adjust the height of the block as needed for the top course of a given wall to conform to a designated door and/or a designated wall height between various standard heights such as twelve inches, eight inches, and four inches. Also, the block maker 206 will include a substation 226 in the form of a hydraulic block cutter (i.e., a hydraulic masonry cutter) to cut or shear the compressed blocks both vertically (to make shorter width blocks as wall installation requires) and at an angle (to fit blocks together). Further, a user interface 228 coupled to the processor 216 allows a user to control the computerized block maker 206 via a control line 230. The user can vary the block production rate from, for example, a manual mode through various increments up to a maximum production rate of approximately 600 compressed blocks per hour. The user can also access technical support from the central database 116 (FIG. 1) which has been monitoring the operational parameter information.

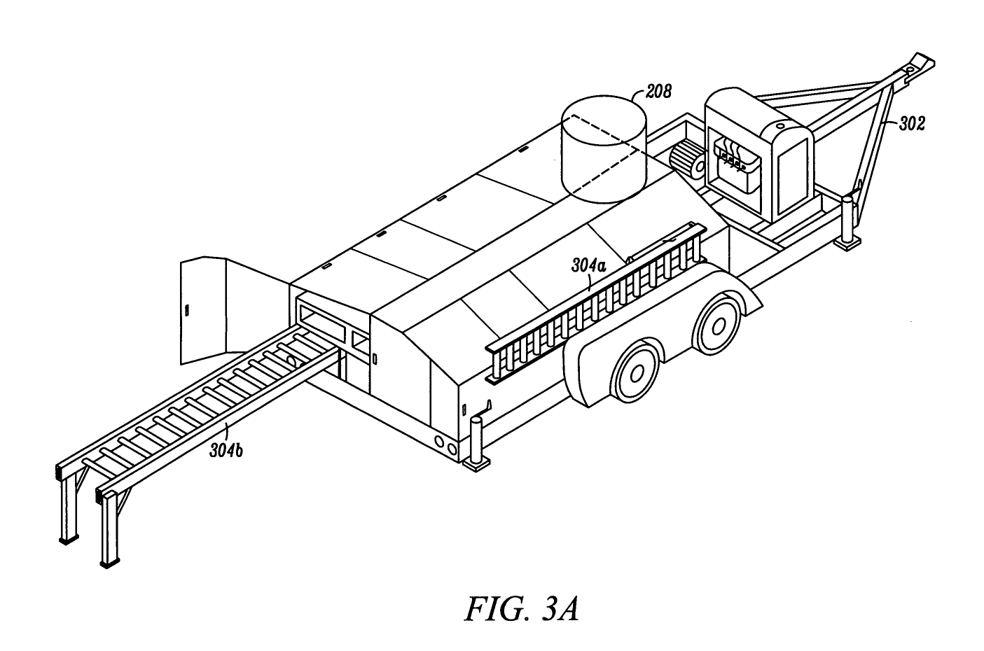

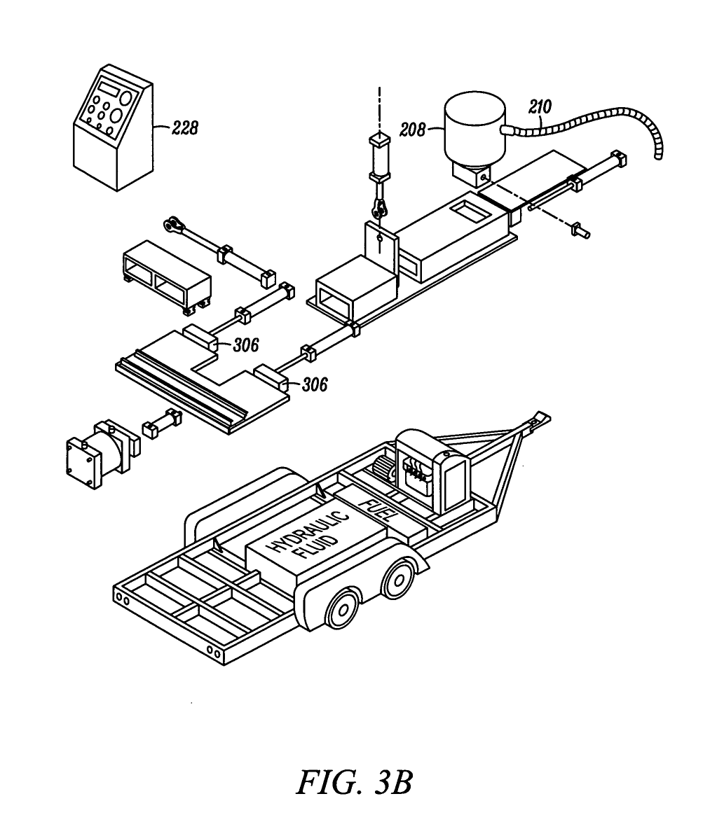

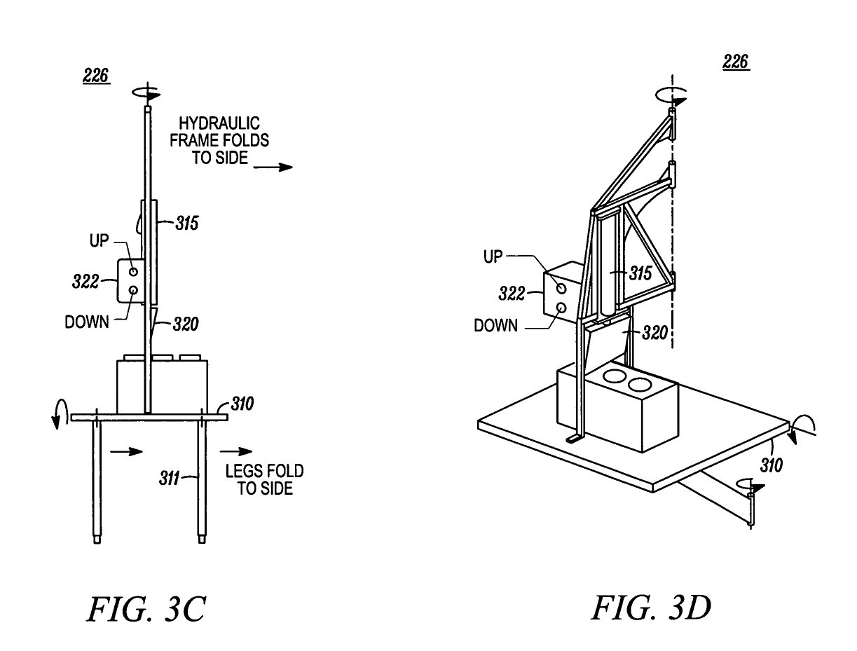

Referring next to FIGS. 3A and 3B, the portable block forming machine 106 is depicted. FIG. 3A is a top, rear, left perspective view of the block forming machine 106 showing a trailer hitch 302 which allows the block forming machine 106 to be towable behind a standard pickup truck. An output block rack 304 is depicted in two positions: the output block rack 304a is stored for transportation and the output block rack 304b is set up for operation. A radiator 208 discharges the heat from the engine 204. In FIG. 3B, a top, rear, left exploded perspective view, the radiator 208 provides waste heat through a vent which is coupled to the hose 210 for feeding the heat from the radiator 208 back to the feeder 207. Various hydraulically movable plates 306 form the heart of the block maker 206.

Referring to FIGS. 3C and 3D, the hydraulic block cutter substation 226 in accordance with the present embodiment is depicted. FIG. 3C is a front planar view of the block cutter 226 and FIG. 3D is a front, right, top perspective view of the block cutter 226. A fold out base 310 folds down and is supported by two fold out legs 311. A compressed masonry block is set on the base 310 and passed under a frame 312 which supports a hydraulic arm 315 coupled to a masonry cutting blade 320. A user interface 322 includes controls for activating the hydraulic arm 315 to force the masonry cutting blade 320 through the compressed masonry block on the base 310. In this manner, the block cutter 226 can cut the compressed block at the worksite 102 (FIG. 1) to any size as needed for building the structure at the worksite 102.

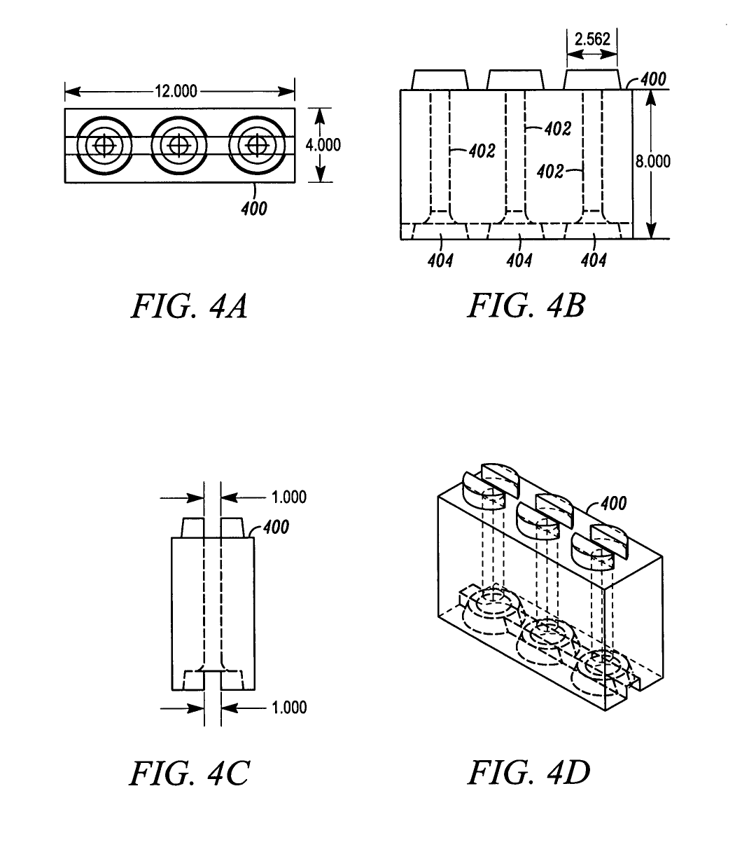

FIG. 4, comprising FIGS. 4A, 4B, 4C and 4D, depicts a compressed block 400 in accordance with the present embodiment. The compressed block 400 is fabricated by the block forming machine 206. FIG. 4A is a top planar view of the compressed block 400; FIG. 4B is a front planar view of the compressed block 400; FIG. 4C is a left side planar view of the compressed block 400; and FIG. 4D is a front, top, left perspective view of the compressed block 400. The compressed block 400 is used for building walls and other support structures and is fabricated with holes 402 at predetermined intervals for inserting metal bars within a constructed wall to stabilize and strengthen the wall. Other hollow spaces (such as hollow space 404) may be formed within the compressed block 400 for the purpose of decreasing the mass of the compressed block 400 so that it may be more easily handled and for the purpose of decreasing the weight of a structure, such as a wall, ceiling or sub-floor.

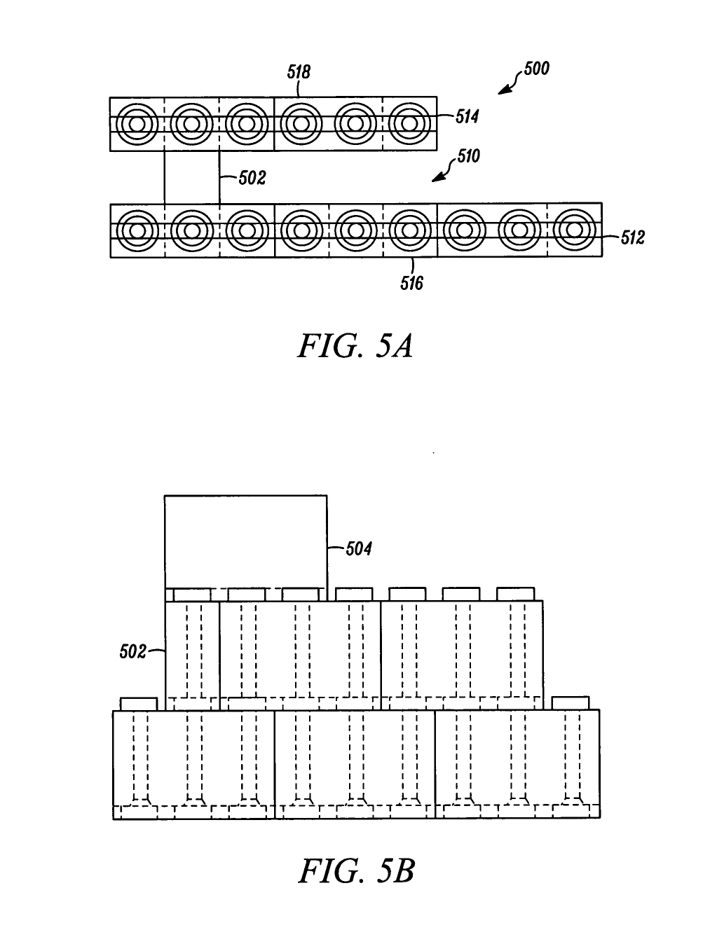

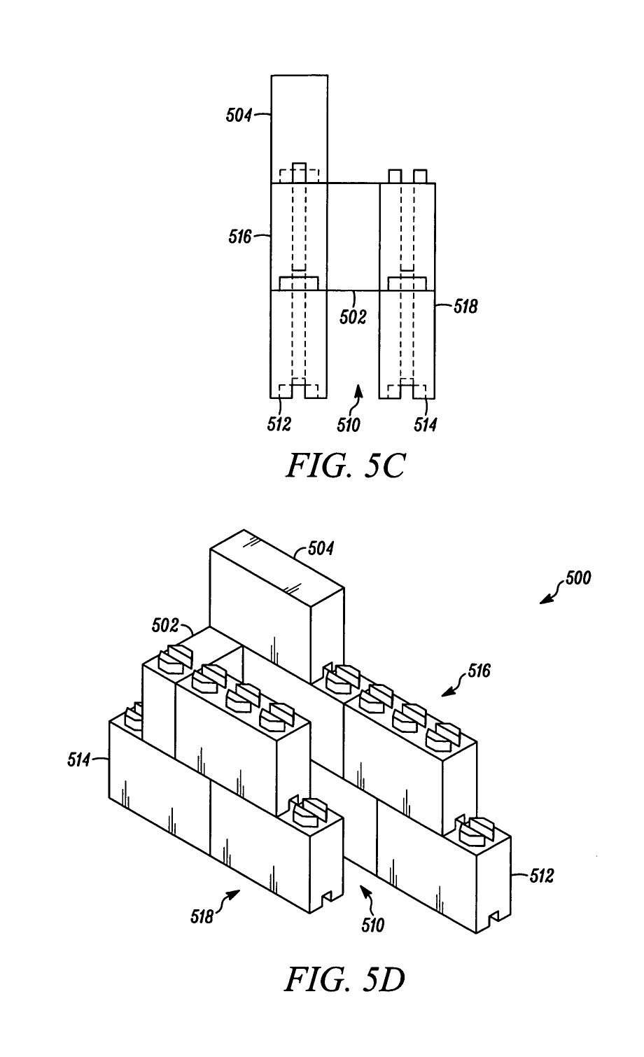

FIG. 5, including FIGS. 5A, 5B, 5C and 5D, depicts a wall structure 500 utilizing a plurality of the compressed block 400. FIG. 5A is a front planar view of the wall structure 500. The wall structure 500 includes a plurality of the compressed block 400 including a bracing block 502 and a cap block 504. The fully interlocked wall structure 500 utilizes the compressed blocks 400, 402, 404 to form a highly energy-efficient dual-wall exterior as clearly seen in FIG. 5D. The dual wall exterior forms a channel 510 between a first wall 512 and a second wall 514 (that is substantially parallel and non-adjacent to the first wall 512) for inclusion of insulation material such as heated air, insulation or solid insulative material. In this manner, the wall structure 500 forms a thermal barrier between the exterior surface of the wall structure 500 (an outer surface 516 of the first wall 512 opposite the channel 510) and interior surface of the wall structure 500 (an inner surface 518 of the second wall 514 opposite the channel 510) by two thermal masses (i.e., the first and second walls 512, 514) sandwiching a thermal resistance (i.e., the insulation material).

The bracing blocks 502 are essential to the stability and strength of the wall structure 500, as the bracing blocks 502 lock the first and second walls 512, 514 together. Unlike wall studs, the bracing blocks 502 are interspersed in the wall and thus do not create floor-to-ceiling breaks in the thermal barrier as wall studs do.

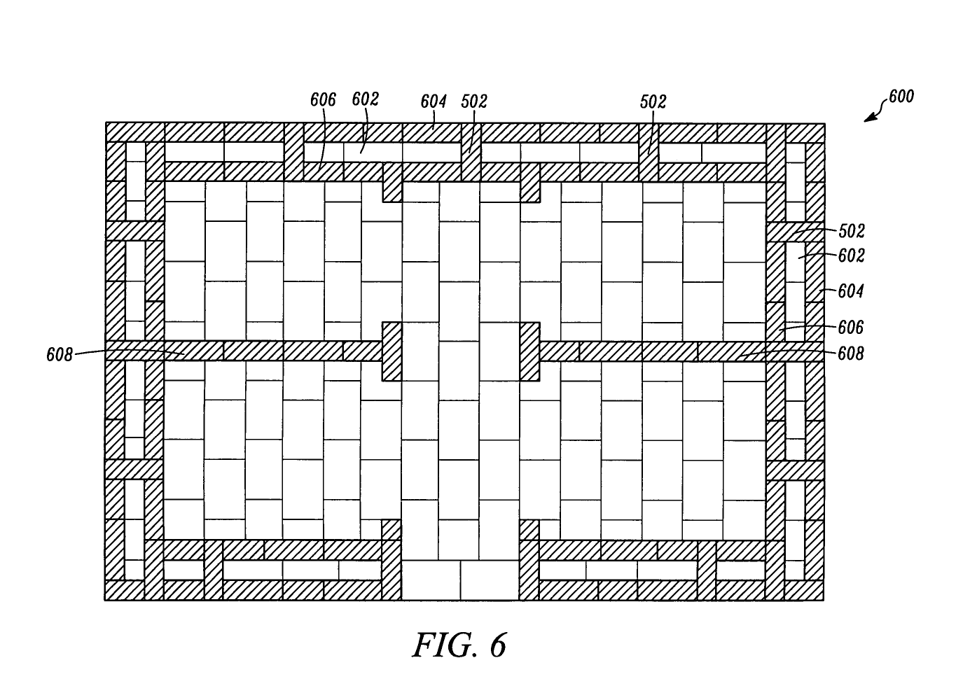

FIG. 6 is a top planar view of a building structure 600 utilizing the exterior dual-wall structures 500 in accordance with a first structure embodiment. The building structure 600 allows for not only insulation material to be placed in the channel 602 between the first wall 604 and the second wall 606, but also construction materials such as conduit, plumbing and electrical wire may be placed therein. In addition, the holes in the compressed blocks 400 in either the outer wall 604 or the inner wall 606 can have rebar or other material passing therethrough for reinforcing the building structure 600, such as in an earthquake zone. As stated above, the bracing blocks 502 also contribute to the stability of the building structure 600. In addition, the holes in the compressed blocks 400 in the interior wall 606 may have the construction material passing therethrough.

Single wall interior partitions 608 are also formed of the compression blocks 400 which, along with the interior walls 606, feature a “chase” system to create a structure-wide network for the installation of water lines, electrical wiring, and structural (rebar) reinforcement. The material of the compressed blocks 400 and the structure of the building structure 600 make the building structure 600 resistant to fire, wind, insect infestation, and sound infiltration.

A horizontal structure 610 is substantially perpendicular to the first and second walls 604, 606 and forms a sub-floor comprised of compressed blocks 400. The horizontal structure 610 has the pre-existing holes of the compressed blocks 400 lined up so that construction materials may be routed through them, the construction materials including, in addition to conduit, plumbing and electrical wiring, climate control elements such as radiant heat elements or hydroponic elements (e.g., temperature controlled water being provided through pipes). The climate control elements (which may be also routed through the interior walls 606) may be coupled to a climate control system for regulating temperatures within each room of the building structure 600 and may include variable refrigerant flow systems (e.g., temperature controlled refrigerant being provided through pipes) for thermal cooling and heating of each room individually. In this manner, the building structure 600 does not require ductwork for provision of heating or cooled air to each of the rooms of the building structure 600.

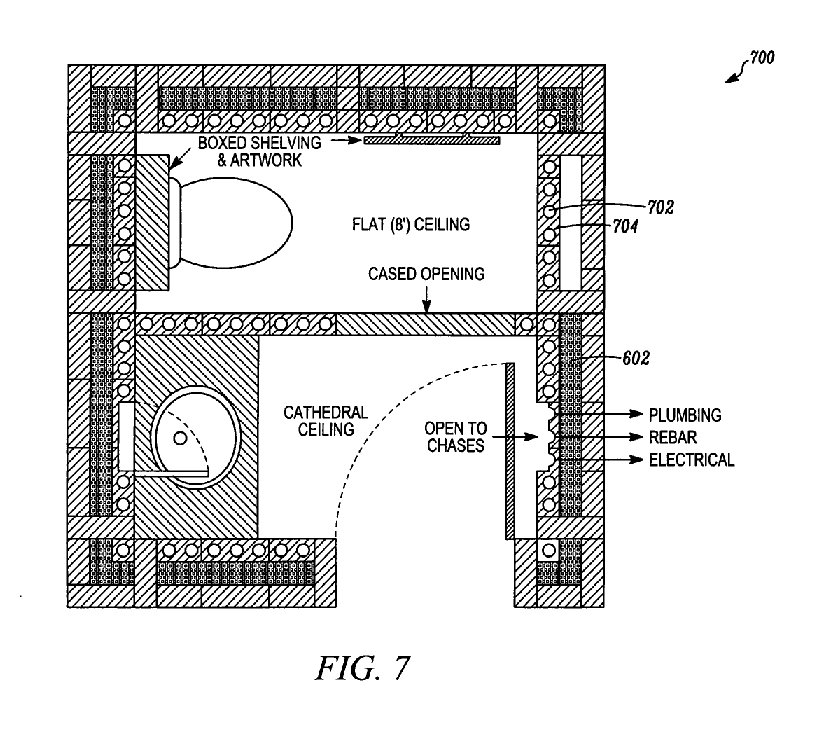

Referring to FIG. 7, a top planar view of a building structure 700, a bathroom structure, is depicted. The building structure 700 includes a view of the holes 702 in the compressed block interior walls 704 where the construction materials is routed to the inner surface of the interior walls 704.

While at least one exemplary embodiment has been presented in the foregoing detailed description of the invention, it should be appreciated that a vast number of variations exist, including a vast number of acceptable shapes, dimensions and structures. It can be seen that present method and system provide and enable an all-in-one system designed for builders to construct as they make the compressed blocks onsite, in a seamless construction process that also allows for easy integration with conventional flooring and roofing, along with variable refrigerant flow heating, and cooling systems which can advantageously provide room-by-room climate control in a centralized system without routing ductwork through the structure.

In addition, in this document, the terms “includes”, “including”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “includes . . . a” does not, without more constraints, preclude the existence of additional identical elements in the process, method, article, or apparatus that comprises the element.

It should further be appreciated that the exemplary embodiment is only an example, and is not intended to limit the scope, applicability, dimensions, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A system for building on a worksite using compressed blocks, the system comprising:
a block machine for manufacturing a plurality of compressed blocks of selected materials, wherein said block machine is portable for locating near said worksite, and further includes:
interchangeable molds for forming a plurality of compressed blocks in a variety of shapes and sizes;
an engine providing hydraulic power; and,
a means for applying heat from said engine to said raw materials prior to compression.

2. The system in accordance with claim 1 wherein said block machine further includes:
a data recording module for measuring and storing usage information and for measuring operational parameter information; and,
a communication module for providing said usage information and said operational parameter information to a central database.

3. The system in accordance with claim 1 wherein said block machine further comprises a block formation module which forms each of said plurality of compressed blocks by compressing said material under a pressure in the range of 2500 to 5000 pounds per square inch (psi).

4. The system in accordance with claim 3 wherein said block formation module forms each of said plurality of compressed blocks from material selected from the group consisting of: common clay, foundry sand, coal ash, construction and demolition debris, waste road asphalt, and waste roof shingles.

5. The system in accordance with claim 1 further comprising a hydraulic block cutter.

6. The system in accordance with claim 1 further comprising at least one structure comprising:
a first wall formed from a first set of said plurality of compressed blocks; and
a second wall formed from a second set of said plurality of compressed blocks; wherein:
said first and second walls are substantially parallel and non-adjacent such that a channel is formed therebetween;
an outer surface of said first wall is opposite said channel and forms an exterior surface of said structure; and
an inner surface of said second wall is opposite said channel and forms an interior surface of said structure.

7. The system in accordance with claim 6 wherein said second set of said plurality of compressed blocks forming said second wall includes holes through which first construction materials may be routed to said interior surface, said first construction materials selected from the group consisting of: conduit, plumbing, and electrical wiring.

8. The system in accordance with claim 7 wherein said at least one structure further comprises a horizontal structure formed from a third set of said plurality of compressed blocks and coupled to said inner surface of said second wall, wherein each of said third set of said plurality of compressed blocks include pre-existing holes through which second construction materials may be routed, said second construction materials comprising climate control elements selected from the group consisting of: radiant heat elements, hydroponic elements and variable refrigerant flow elements.

9. The system in accordance with claim 6 wherein said plurality of compressed blocks includes one or more bracing blocks, and wherein said bracing blocks are laid perpendicular to and connecting to said first wall and said second wall to provide stability thereto.

10. A method for building a structure comprising the steps of:
providing a compressed block machine at or near a worksite for the structure;
providing reusable material at or near the worksite as block material for forming a plurality of compressed blocks, the reusable material comprising one or more of common clay, foundry sand, coal ash, construction and demolition debris, waste road asphalt, and waste roof shingles;
manufacturing each of the plurality of compressed blocks by the compressed block machine by compressing a measured portion of the block material under a pressure in the range of 2500 to 5000 pounds per square inch (psi); and
forming the structure on the worksite from one or more of the plurality of compressed blocks;
wherein the step of manufacturing each of the plurality of compressed blocks further comprises the steps of:
measuring usage information and operational parameter information for the compressed block machine;
determining location information for the compressed block machine; and
transmitting the usage information, operational parameter information, and location information.

11. The method in accordance with claim 10 wherein the compressed block machine includes an engine for generating the pressure for compressing the block material to form each of the plurality of compressed blocks, and wherein the step of manufacturing each of the plurality of compressed blocks further comprises softening the block material prior to compression thereof.

12. A building structure including compressed blocks, the building structure comprising:
a first wall formed from a first set of the compressed blocks;
a second wall formed from a second set of the compressed blocks; and
one or more bracing blocks from a third set of the compressed blocks, wherein one or more bracing blocks interspersedly connect the first wall to the second wall, and wherein (a) the first and second walls are substantially parallel and non-adjacent such that a channel is formed therebetween, (b) an outer surface of the first wall is opposite the channel and forms an exterior surface of the structure, and (c) an inner surface of the second wall is opposite the channel and forms an interior surface of the structure.

13. The structure in accordance with claim 12 further comprising insulation situated in the channel between the first and second walls.

14. The structure in accordance with claim 12 further comprising construction materials situated within the channel between the first and second walls, the construction materials selected from the group of construction materials comprising conduit, plumbing, and electrical wiring.

15. The structure in accordance with claim 14 wherein the compressed blocks forming the second wall include holes through which the construction materials are routed to the interior surface of the structure.

16. The structure in accordance with claim 12 further comprising a horizontal structure formed from a third set of the compressed blocks and coupled to the inner surface of the second wall, wherein the third set of the compressed blocks includes pre-existing holes through which construction materials are routed.

17. The structure in accordance with claim 16 wherein the second construction materials are selected from the group of materials comprising climate control elements, conduit, plumbing, and electrical wiring.

18. The structure in accordance with claim 17 wherein the climate control elements are selected from the group of climate control elements including radiant heat elements, hydroponic elements, and variable refrigerant flow elements.

19. The structure in accordance with claim 17 wherein the climate control elements are coupled to a climate control system for regulating temperatures within the building structure.

20. The structure in accordance with claim 16 wherein the horizontal surface is substantially perpendicular to the first and second walls and forms a floor.
